(19) United States
(12) Patent Application Publication
(10) Pub. No.: US 2006/0113251 A1
(43) Pub. Date: Jun. 1, 2006

(54) Disaster response unit

(76) Inventors: Dennis McGuire, Stuart, FL (US); Mickey Donn, Stuart, FL (US)

Correspondence Address: MCHALE & SLAVIN, P.A., 2855 PGA BLVD, PALM BEACH GARDENS, FL, 33410, US

(21) Appl. No.: 11/264,659

(22) Filed: Nov. 2, 2005

Related U.S. Application Data
(63) Continuation-in-part of application No. 11/075,844, filed on Mar. 7, 2005.
(60) Provisional application No. 60/616,756, filed on Oct. 6, 2004.
(60) Provisional application No. 60/551,481, filed on Mar. 5, 2004.

(51) Int. Cl. C02F 1/44

(52) U.S. Cl. 210/652

(57) ABSTRACT

A disaster response unit is a self contained vehicle that may be moved by land, air or sea to an area that has no utilities. The unit has a trained crew and living quarters for them. The crew provides security for the unit and provides services to the public. The unit has it's own motor driven electrical generator and a complete communications suite. The unit is capable of making potable water from most sources of water, such as polluted reservoirs, lakes, streams, and fire hydrants. The unit includes a water distribution system to allow the public to draw potable water. The unit also has a series of showers for the public to provide basic hygiene.

### RELATED APPLICATIONS

This application is a continuation in part of U.S. application Ser. No. 11/075,844 entitled Modular Waste Water REMEDIATION SYSTEM AND METHOD OF USING claiming a priority filing date of Mar. 5, 2003 based on Provisional Application No. 60/551,481 the contents of which are incorporated herein by reference, and related to U.S. application Ser. No. 11/244,317 entitled MOBILE EMERGENCY FILTRATION SYSTEM filed Oct. 5, 2005 claiming the filing date of Provisional Application No. 60/616,756 the contents of which are incorporated herein by reference.

### FIELD OF THE INVENTION

This invention relates to the field of disaster recovery and in particular to a self sustaining vehicle for producing and distributing potable water from any source of water available for use directly after a disaster; the vehicle also serves as living quarters for rescue, security, or other official personnel and carries communications equipment facilitating integration into commercial telecommunications, as well as, the command and control net of the emergency response.

### BACKGROUND OF THE INVENTION

In the aftermath of the events of Sep. 11, 2001, the emergency response capability of most governmental agencies charged with such a mission has undergone a thorough review. In reviewing the tools and programs available to emergency response agencies, such as the police, fire and rescue departments, hospitals, etc. of towns, cities, counties, states, and the federal government, certain inadequacies were uncovered. For example, at the time of the attack it was discovered that most water districts and municipalities did not have any capability of responding to contamination of the water supply to assure usable water for the public in the affected area.

In the aftermath of the natural disasters caused by hurricane Katrina in AD 2005, it became apparent that certain inadequacies persisted in treating large scale disasters, including the failure to fully implement existing emergency plans and the lack of specifically designed equipment capable of being immediately deployed into disaster areas to supply basic needs for the inhabitants. Such inadequacies include the inability of the survivors to reach relief supplies, the inability of the relief supplies to reach the survivors, and the lack of facilities to help the survivors and/or workers rebuilt the infrastructure.

There are a multitude of mobile vehicles and trailers for temporary housing however, these vehicles rely on storage tanks with a fixed amount of potable water or they are adapted to hook up to a supply of potable water. For example, U.S. Pat. No. 4,652,041 to Barber et al, discloses an expandable trailer with multiple living units. This allows over the road movement of the trailer and an expanded enclosed space after the trailer is on site.

U.S. Pat. No. 6,675,540 to Rokes, discloses a portable building that may be used for general purposes, such as meetings, classrooms, entertainment and living space. The building may be moved by trailer and unloaded at a prepared site. The building may withstand hurricane force winds.

U.S. Pat. No. 4,841,897 to Claflin, discloses a trailer mounted on a wheeled chassis that may be laid on its side for installation on site. This allows over the road transportation but expanded space on site.

Published Application, Pub. No. 2005/0022890, to Demchick, discloses another recreational trailer with a filtered water system including an outdoor outlet.

Published U.S. Applications, Pub no. 2004/0262206 and Pub. No. 2005/0016906 to Gettman disclose mobile emergency response apparatuses with an independent electrical power source which are each capable of producing and distributing potable water by treating raw water, by a sodium ion exchange system, and providing telecommunications, as well as, GPS location. The apparatus does not have any facility for crew or security.

An additional problem with the prior art is the inability to recognize that a disaster must be addressed on a localized level, similar as fire fighters must be localized. The use of large scale equipment, such as that employed by the U.S. government following Hurricane Katrina, produced potable water but survivors could not reach the location were the equipment was placed. Such equipment must be placed throughout the community so that the individuals residing in the community can reach such equipment on foot, and carry water from the equipment by hand.

What is lacking in the art is a mobile disaster response unit that can be positioned within the disaster zone which provides accommodations for a 24 hour work crew and security, a water treatment system capable of converting non-potable water into potable water, a water distribution system, an independent electrical power system, and a telecommunications system.

### SUMMARY OF THE INVENTION

Disclosed is a disaster response unit defined as a self contained vehicle that may be moved by land, air or sea to an area that has no operating utilities. The unit has living quarters for a trained crew to provide security for the unit and operational support. The unit employs a motor driven electrical generator capable of operating a complete communications suite and water treatment equipment capable of making potable water from most sources of water, such as polluted reservoirs, lakes, streams, and fire hydrants. The unit includes a water distribution system to allow the public to draw potable water and a series of showers for the public to provide basic hygiene. The electrical generator including sufficient power to operate pumps in drawing of the water but efficiently sized to provide extended operation on minimal fuel.

Accordingly, it is a primary objective of the instant invention to provide an emergency response unit in the form of a self-contained enclosure housing work space and accommodations for a crew, a water treatment system and a telecommunications system which is mobile by land vehicle, air lift, and water.

It is another objective of this invention to provide a modular raw water treatment system, producing potable water, that uses multiple treatment processes to neutralize or remove contaminants in the raw water available at the site and generated during site cleanup or decontamination activities providing area inhabitants with drinking water and showering facilities. The system incorporates an initial chemical treatment for super halogenation of raw water based upon specific site situations. The super chlorinated treated water is then pumped to a chemical addition and reaction/contact tank to dechrolinate the treated water then to a centrifuge for solids separation. A polishing sand filter is used to remove fine particulate and carbon adsorption removes dissolved organics. An E33 media can be used to remove arsenic present in the effluent water. The final treated water is passed through an ultra filtration unit to further reduce any particulate material. Depending on the specific influent water, the treated water can be further passed through a reverse osmosis unit to reduce total dissolved solids. This system is the subject of U.S. patent application Ser. No. 11/075,844, to McGuire, and is incorporated herein by reference.

It is a further objective of the instant invention to provide the unit with an independent electrical power source, electrical bus and wiring harness for powering all accessories and systems.

It is yet another objective of the instant invention to provide the unit with environmental controls including air filtering, heating and cooling.

It is a still further objective of the instant invention to provide a potable water distribution system to allow public access to drinking water and hygiene facilities.

It is still another objective of the invention to teach the use of infrastructure replacement units that are sized to provide community support for areas that have little or no access to transportation by providing basis necessities that can be reached by foot.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a pictorial of a disaster recovery unit;

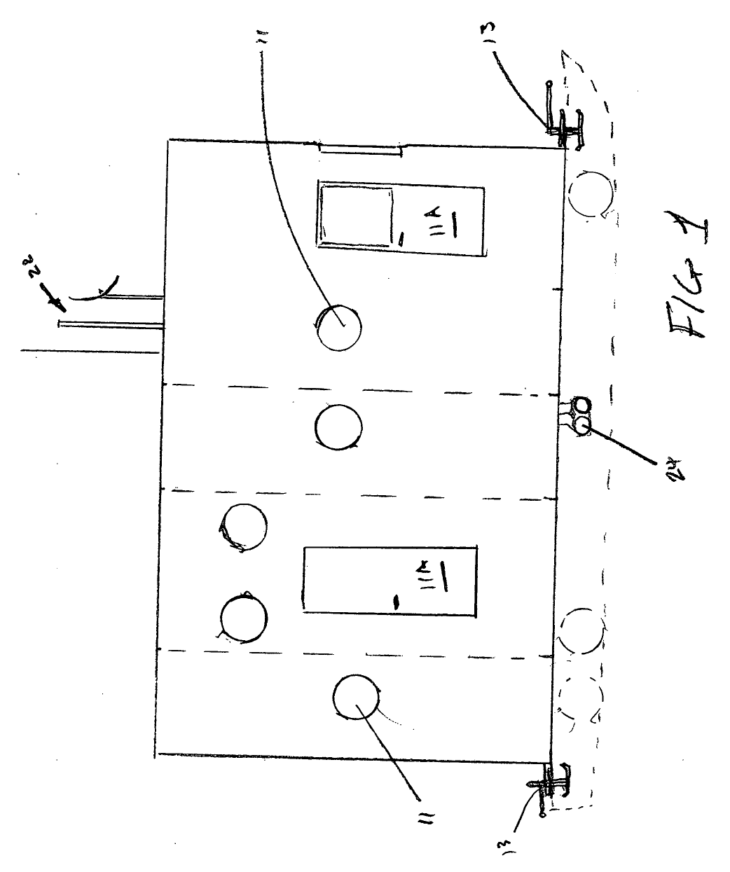

FIG. 2 is a pictorial schematic depicting equipment positioning in the disaster recovery unit.

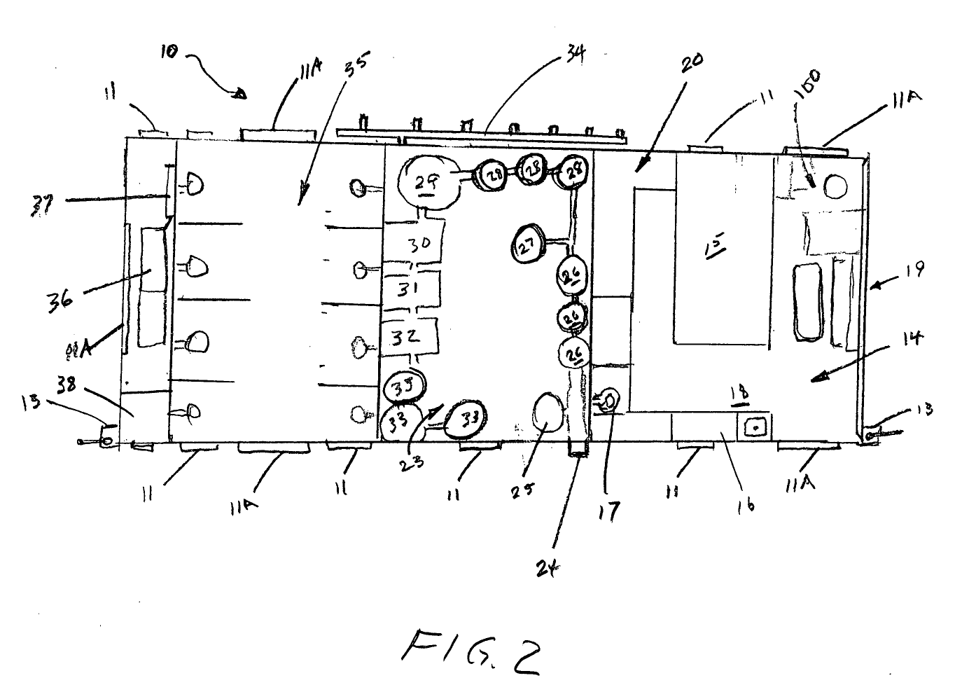

FIG. 3 is a pictorial schematic depicting equipment positioning in another embodiment of the disaster recovery unit.

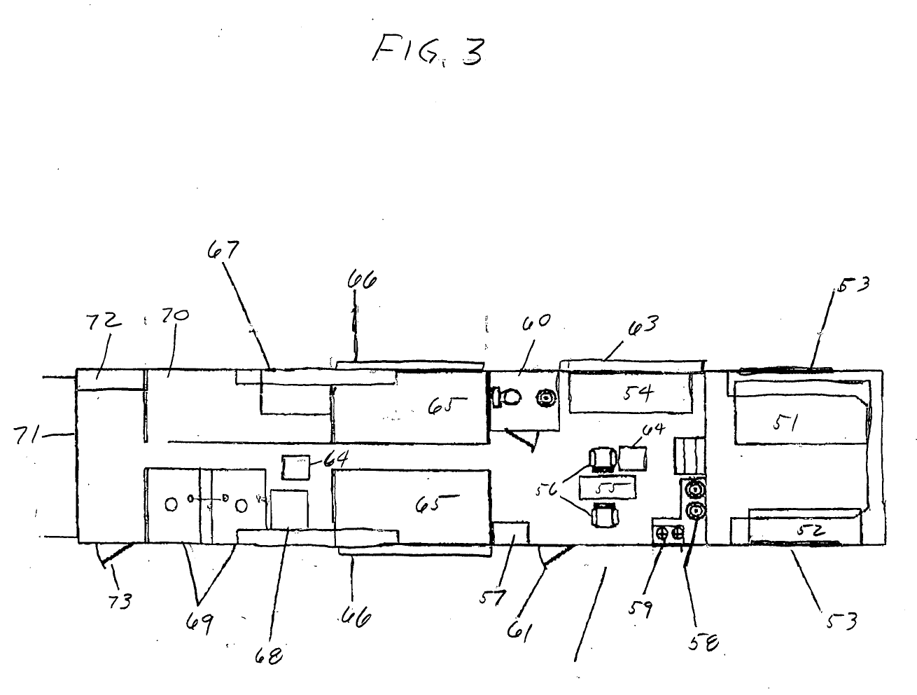

### DETAILED DESCRIPTION OF THE INVENTION

The mobile disaster response unit 10 has a integral frame and building structure. The building structure is of sufficient strength and rigidity to support the weight of the building and its contents without significant deformation. The building structure has windows 11 and doors 11A for ingress and egress and for viewing the surrounding area. The windows may be sealed or openable. The building structure may be mounted on wheels, as a towed vehicle or it may be self powered with a driving station 100. The building structure may be moved on a trailer or air-lifted in the hold of an aircraft or suspended by sling. The wheels may be removed to facilitate shipping and installation on site. The building structure may also be sized to fit in a standard ISO 20 ft. container with inside measurements of 20 ft. long, 8 ft. wide, and 8.5 ft. high. The building would measure 19 ft. long×7.5 ft. wide×7 ft. high. Rollers may be included on the bottom of the building to facilitate loading of the structure into the container.

In addition, the bottom surface of the building structure may be sealed to allow movement by water, such as on the deck of a boat or towed by small boat with pontoons temporarily or permanently affixed to the bottom.

Leveling jacks 13 are located at the corners of the housing structure to anchor and level the housing structure on site. The jacks may be manual or powered. The jacks also serve as lifting points for airlift. Also provided are external lighting on the housing structure for identification and security.

The housing structure has living quarters 14 for an operating crew/security detail. Bunk beds 15 and storage compartments/closet 16 are built-in. A bathroom 17 has a shower, commode and sink plus storage. A galley kitchen 18 with a microwave oven and/or an electric stove, sink, refrigerator and storage for food, cook ware, and utensils is next to an eating area 19 with a table and chairs/benches, all of which provide the basic needs of the crew for continuous occupation of the housing structure.

Adjacent the living quarters 14 is the communications hut 20 containing the telecommunication equipment 21, such as microwave, satellite, two-way radio/TV, and land line connections. All necessary antennae 22 are mounted on the housing structure with jacks in the hut wall. A microwave mast may be mounted to assure line-of-sight relationship with a microwave tower. At least one two-way radio should include the military frequencies for local coordination with nearby units. Also, one two-way radio should be capable of communicating on the local sheriff's or municipality frequency and the state police frequency. Other communications gear, such as teletype and facsimile are included.

As part of the disaster response, the communications hut would be equipped to provide message service to the public to permit notification of the next-of-kin. This could be a quantity of cell phones or use of the more sophisticated equipment as a relay.

The water treatment system is designed to meet the potable water standards established by the World Health Organization (WHO). The water treatment system 23 is a Multiple Stage Filtration Process which includes an initial halogen-based chemical treatment for disinfection/deactivation. For example, the use of household bleach (5.25 percent sodium hypochlorite solution) at a ratio of one part bleach per 10 parts water may be used as a wiping agent to decontaminate solid surfaces after a biological event. A 1:10 solution of bleach and the water would have a chlorine concentration of approximately 2,500 mg/L.

The raw water intake 24 is connected to a source of raw water, such as a pond, reservoir, flowing stream, fire hydrant or the like, by a flexible hose or conduit. In the worst case scenario the source of raw water will be un-pressurized sea water with a total dissolved solids (TDS) as high as 45,000 parts per million (ppm) consisting of silt, debris, fecal contamination, petroleum based contaminants (oil, gasoline, insecticides, volatile organics, etc.) and unknowns such as industrial waste products. In the absence of water pressure, a pump is used to collect raw water. As the raw water flows into the water treatment system a halogen, such as chlorine, is introduced to the flow from a supply tank 25. The chlorinated water is collected in a collection tank 26. The result of the initial chemical treatment of the raw water is a super chlorinated treated water which is generally, unusable for human contact.

Further treatment of the super-halogenated water to produce potable water requires chemical addition/neutralization for de-chlorination, centrifugation, sand filtration, arsenic absorption through E33 media, carbon adsorption, ultra filtration and reverse osmosis.

The de-chlorination process involves dosing of calcium thiosulfate 27 in the stream of treated water flowing from the collection tank(s) 26 to a holding tank(s) 28. The treated water may be pumped to a centrifuge 29, if necessary, for solids removal. A sand filter 30 is used to remove fine particulate and carbon adsorption removes dissolved organics. E33 Filter media absorbs arsenic present in the treated water. The final product is passed through an ultra filtration unit 31 to further reduce any particulate material present in the treated water. Depending on the specific application, the treated water can be run through a reverse osmosis unit 32 to control dissolved salts.

The resulting potable water is pumped into storage tanks 33 which are connected to the distribution system. The distribution system terminates in a manifold 34 of valved spigots located on the exterior of the housing structure and easily accessible to the public for drawing potable water.

The distribution system has another terminus in the multiple showers 35 located in the housing structure 11 in a series of stalls 12. The supply lines to the showers may be split into hot and cold sides. The hot side line runs through an electrical heater(s) before entry into each shower head. Also, hot water is supplied to the living quarters from the heater(s). The drains of the showers, as well as, the drains in the living quarters return wastewater to a drain tank(s) for eventual re-circulation as raw water. The housing structure has doors 11A on opposite sides of the showers to facilitate an orderly flow of people.

The disaster response unit 10 has it's own electrical system powered by motor driven generator(s) 36 connected to a central electrical bus 37. The necessary wiring to all the electrical devices on the disaster response unit including lights, radios, water treatment, hot water heaters, and electrical receptacles is supplied by a wiring harness connected to the electrical bus. The bus 37 also has a converter and receptacle to plug into a commercial electrical grid, if one is available.

The housing structure would be supplied with a central ventilation system 38 which would include air sensors for the detection of the air quality and filters for removing air bourne contaminants and heat pump for heating and cooling the inside air of, at least, the living quarters 14.

In a preferred embodiment, if the source of water is not under pressure, the inlet pump would be able to lift the source of water 10 ft., provide a flow rate of 80 GPM at a pressure of 50 PSI pressure. If the source is under pressure, a pump bypass is available. The inlet of the pump is provided with a filter basket. The raw water stream is first treated with ozone (O₃) utilizing a corona discharge ozone feed. An injector is used to insure proper mass transfer. 6 to 8 PPM of O₃ are added to the raw water to insure a CT (concentration in mg/l×time in minutes) of 1.2. The water stream is then passed through a 20 micron wire mesh filter. Next the water stream is passed into a 200+ gallon steel retention tank for solids separation. This tank is provided with a blow-down valve for the discharge of accumulated solids and winter draining. A gas-off valve is provided at the top of the tank for the release of excess O₃. The next stage includes a filtration unit to remove the solids with a particle size above 10 microns. These filters are dual alternating pressure differential controlled back-washing particulate filters. This filtration unit is housed in a steel tank which is provided with a valve in the lower portion and a strainer for drain down. There is a port provided in the lower portion of the tank for removal of the filter media. This is followed by a absorbing carbon column for the removal of oil. The column is housed in a steel tank which is provided with a valve in the lower portion thereof and a strainer for drain down. A port is provided in the lower portion of the tank for the removal of and replacement of the carbon media. After this the stream flows through an adsorbing carbon column which is provided with a automatic gas vent for removal of the remaining excess O₃ and organic vapors. This column is also housed in a steel tank provided with a drain. A port is also provided in the tank for the removal of and replacement of the carbon media. This is followed by 50 to 5 micron dual depth cartridge filters. This system is provided with isolation valves and pressure warnings to permit exchange of the filters without interruption of the stream flow. Next an ultraviolet light treatment eliminates the remaining O₃ and provides a final biocide treatment. This is followed by an ultra filtration system composed of membranes. This system is provided with an automatic flush to keep the system operational. A Reverse Osmosis (RO) water treatment follows. Operation of the automatic flush of the ultra filtration system is connected to the Reverse Osmosis system to shut down the Reverse Osmosis system to prevent contamination during the flushing operation. Anti-scaling chemicals are injected into the stream for prevention of mineral buildup in the treatment elements. This injection system may also be employed as a clean in place system for the introduction of liquid chlorine into the system for disinfection and to prevent cross contamination of the treatment elements.

In operation, the mobile disaster unit would be delivered to a devastated area over land, by air, or over water and set-up near a source of water. The unit is supplied with enough provisions for the crew, chemicals for the water treatment module, and fuel for the generator to remain on site for an extended period of time. The crew of one, two or more personnel would be trained in setting up the unit and operating the systems without support or using local help. By remaining with the unit on a 24 hours daily basis, tampering, pilfering and other damage is reduced or prevented. The crew services the systems on board including replenishing the chemicals and removing waste products for disposal. In addition, the services of the unit would be continuously available to the public according to their needs.

The disaster response unit is a natural gathering place for survivors as they come to get water, take a shower, and make necessary calls. The unit's communications system links the people with the outside world and keeps them abreast of developments affecting them. For example, a large TV can be mounted on the outside of the housing structure. In addition, the communications serve to call for evacuation of medical emergencies.

In another embodiment the housing structure is designed for use by one or two individuals, for example the mayor of a city or other leaders. The living quarters are designed to provide areas for office space required to direct the recovery operations. A bed 51 and desk 52 are located in the raised front portion of the trailer which also includes windows 53. A couple of steps lead down to the main living area. This area is provided with a combination sofa/bed 54, table 55, chairs 56, refrigerator 57, sink 58, microwave 59 and bathroom 60. A door 61 is provided for access into the trailer and a window 62 for light. A slide out unit 63 is available to increase the area of this portion of the trailer. The communications area may be located in the slide out area. This includes telecommunication equipment, such as microwave, satellite, two-way radio/TV, teletype, facsimile and land line connections. All the necessary antennae are mounted on the roof of this area. An air conditioner 64 is also located on the roof.

Adjacent the main living area is the water treatment equipment 65 which is provided with an inlet for the introduction of non-potable water. Doors 66 are provided for access to this equipment. An electrical generator 67 is located on one side of the trailer and a clothes washer/dryer 68 on the opposite side. Adjacent the washer/dryer are showers 69. Opposite the showers is a fuel tank 70. Another air conditioner 64 is located on the roof of this area.

At the end of the trailer area 71 is provided for the location of the controls and gauges required to operate the equipment in the trailer. A central ventilation system 72 is located in this area. This system includes air quality sensors, filters for removing air bourne contaminants and heating means for the treated air when necessary. A door 73 is provided for access into the trailer. External lighting is provided on the trailer for identification and security.

All patents and publications mentioned in this specification are indicative of the levels of those skilled in the art to which the invention pertains. All patents and publications are herein incorporated by reference to the same extent as if each individual publication was specifically and individually indicated to be incorporated by reference. The filtration plant illustrated herein has a capacity to treat approximately 26 gallons per minute (100 Lpm) on a batch or continuous flow basis.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

What is claimed is:

1. A mobile disaster response unit for independent deployment in the field comprising a housing structure with an integral frame, said housing structure of sufficient strength and rigidity for transportation without deformation, said housing structure being subdivided into distinct areas, one area having personnel living quarters for a crew, a second area having an interconnected water treatment system including at least one raw water inlet and a potable water outlet, a third area having a telecommunications system, a fourth area having hygiene facilities interconnected with said outlet of said water treatment system, and a fifth area housing an electrical generator and electrical bus, said housing structure including an electrical harness for electrically connecting all accessories and systems to said electrical bus, and said housing structure including a potable water distribution system.

2. A mobile disaster response unit of claim 1 wherein said water treatment system includes a means for super chlorinization of a contaminated flow of raw water and means for de-chlorinating said flow to produce treated potable water.

3. A mobile disaster response unit of claim 2 wherein said telecommunications area includes means for voice and text messages using one of the group consisting of satellite, microwave, radio, TV or land line.

4. A mobile disaster response unit of claim 1 wherein said telecommunications area includes means for voice and text messages using one of the group consisting of satellite, microwave, radio, TV or land line.

5. A mobile disaster response unit of claim 4 wherein said hygiene facilities include a plurality of shower stalls each having a shower head connected to said outlet.

6. A mobile disaster response unit of claim 1 wherein said hygiene facilities include a plurality of shower stalls each having a shower head connected to said outlet.

7. A mobile disaster response unit of claim 2 wherein said hygiene facilities include a plurality of shower stalls each having a shower head connected to said outlet.

8. A mobile disaster response unit of claim 7 wherein said distribution system includes a manifold attached to said housing structure, a plurality of spigots connected to said manifold, each of said spigots having a manual valve.

9. A mobile disaster response unit of claim 1 wherein said distributions system includes a manifold attached to said housing structure, a plurality of spigots connected to said manifold, each of said spigots having a manual valve.

10. A mobile disaster response unit of claim 2 wherein said distributions system includes a manifold attached to said housing structure, a plurality of spigots connected to said manifold, each of said spigots having a manual valve.

11. A mobile disaster response unit of claim 3 wherein said distributions system includes a manifold attached to said housing structure, a plurality of spigots connected to said manifold, each of said spigots having a manual valve.

12. A mobile disaster response unit of claim 2 wherein said super chlorinated water is fed into a collection tank, said means for de-chlorinating include dosing of calcium thiosulfate in the stream of treated water flowing from said collection tank to a holding tank.

13. A mobile disaster response unit of claim 12 wherein said de-chlorinated water moves to a filtration unit to further reduce any particulate material.

14. A mobile disaster response unit of claim 13 wherein said filtered water continues through a reverse osmosis unit.
